(19) United States
(12) Patent Application Publication
(10) Pub. No.: US 2018/0087675 A1
(43) Pub. Date: Mar. 29, 2018

(54) SELF-RELIEVING BALL VALVE SEAT ASSEMBLY

(71) Applicant: Cameron International Corporation, Houston, TX (US)

(72) Inventor: Mircea Balan, Moore, OK (US)

(21) Appl. No.: 15/276,108

(22) Filed: Sep. 26, 2016

(51) Int. Cl. F16K 5/06

(52) U.S. Cl. CPC F16K 5/0689; F16K 5/0657

(57) ABSTRACT

A ball valve includes a housing, a ball disposed within a cavity of the housing and configured to rotate between an open position and a closed position. The ball valve also includes an annular seat assembly positioned between the housing and the ball, and the annular seat assembly has an annular seat body having a ball-contacting surface configured to contact the ball and having an annular groove. The annular seat assembly also has an annular seal positioned within the annular groove, and the annular seal is configured to contact and to form a seal between the annular seat body and the housing and enables the annular seat body to move relative to the housing to automatically relieve a cavity pressure within the cavity across the annular seat assembly into an upstream bore of the housing.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Ball valves are employed to open or close to enable or block a flow of fluid in a variety of applications. Typical ball valves may include a body, an adapter, a rotatable ball disposed within a body cavity defined between the body and the adapter, and a stem coupled to the ball. However, when the ball rotates to a closed position to block the flow of fluid, some of the fluid may become trapped in the body cavity of the ball valve. The pressure of the trapped fluid within the body cavity may increase, such as due to temperature variations, for example. If not vented, the pressure may adversely affect surrounding parts, result in leakage or release of the fluid to the atmosphere, and/or increase torque needed to move the ball toward the open position.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 a cross-sectional side view of a ball valve, in accordance with an embodiment of the present disclosure;

FIG. 2 is a cross-sectional side view of a seat assembly that may be used in the ball valve of FIG. 1, in accordance with an embodiment of the present disclosure;

FIG. 3 is a cross-sectional side view of the seat assembly of FIG. 2 positioned on an upstream side of a ball within the ball valve of FIG. 1, in accordance with an embodiment of the present disclosure;

FIG. 4 is a cross-sectional side view of the seat assembly of FIG. 2 positioned on a downstream side of the ball of the ball valve of FIG. 1, in accordance with an embodiment of the present disclosure;

FIG. 5 is a cross-sectional side view of the seat assembly of FIG. 2 positioned on the upstream side of the ball within the ball valve of FIG. 1, wherein the seat assembly is separated from the ball, in accordance with an embodiment of the present disclosure; and

FIG. 6 is a cross-sectional side view of a seat assembly that may be used in the ball valve of FIG. 1, in accordance with another embodiment of the present disclosure.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The disclosed embodiments relate generally to self-relieving seat assemblies for use within a floating ball valve. The seat assemblies may be positioned between a ball and a housing of the ball valve, and the seat assemblies may be annular seat assemblies having a seat body and a seal that supports a biasing member. During operation of the ball valve, the seat assemblies and the ball are configured to move (e.g., float) relative to the housing of the ball valve in response to a pressure differential between a cavity located between an upstream seat assembly and a downstream seat assembly, a bore upstream of the ball, and/or a bore downstream of the ball. As discussed in more detail below, when the ball valve is in a closed position, the seat assemblies may move relative to the housing and/or relative to the ball to relieve pressure (e.g., pressure within the cavity), while blocking fluid flow across the ball valve (e.g., between the bore upstream of the ball and the bore downstream of the ball). In the disclosed embodiments, the seat body and the seal may be physically separate structures, which may enable use of different materials for these components, thereby improving the sealing capabilities and/or the overall life cycle of the seat assemblies, for example. Furthermore, such a configuration may facilitate manufacturing of the seat assemblies, maintenance operations, and/or repair operations, for example.

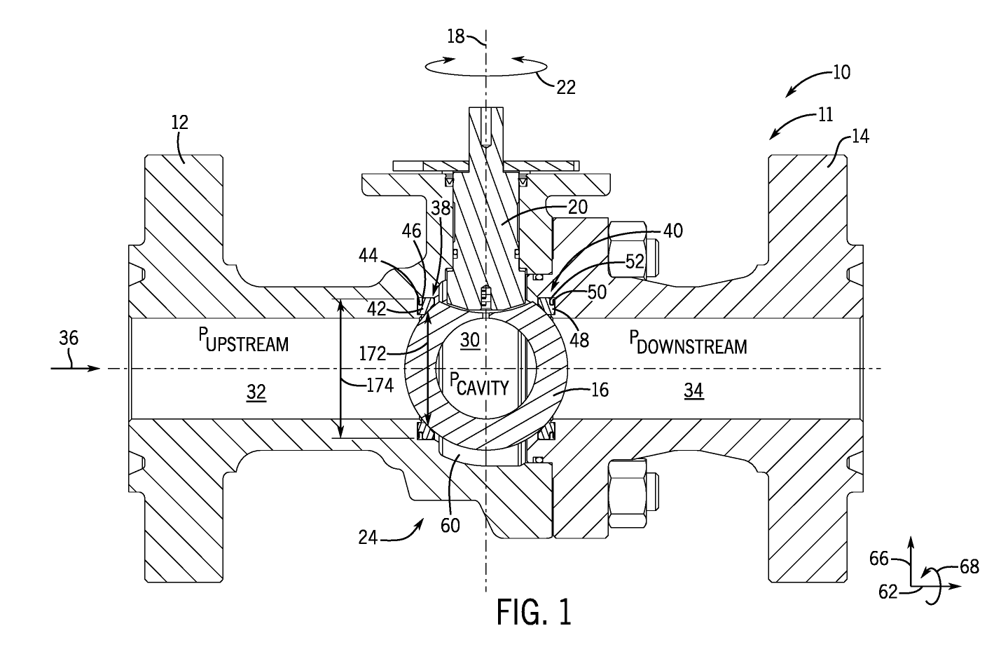

Turning now to the figures, FIG. 1 is a cross-sectional side view of a ball valve 10, in accordance with an embodiment. The ball valve 10 includes a housing 11, which may be formed by an annular upstream housing 12 (e.g., body) and an annular downstream housing 14 (e.g., adapter) that are configured to mate with each other such that a seal is created between the upstream housing 12 and the downstream housing 14. The ball valve 10 includes a ball 16 configured to rotate between the illustrated closed position 24 and an open position about a rotational axis 18, as shown by arrow 22. As shown, the ball 16 is coupled to a stem 20 such that rotation of the stem 20 (e.g., via a hydraulic or pneumatic or electronic actuator or via a handle that may be operated manually) causes the ball 16 to rotate.

In the closed position 24, the ball 16 blocks fluid flow through the ball valve 10. As shown, in the closed position 24, a bore 30 of the ball 16 is generally perpendicular to an upstream bore 32 defined by the upstream housing 12 and a downstream bore 34 defined by the downstream housing 14, such that fluid is blocked from flowing through the ball valve 10 (e.g., from the upstream bore 32 to the downstream bore 34). In an open position, the bore 30 of the ball 16 is aligned with the bores 32, 34 to enable fluid flow through the ball valve 10. Thus, when the ball valve 10 is in the open position, a fluid 36 may enter through the upstream housing 12 and exit through the downstream housing 14. As used herein, the terms upstream and downstream are defined with respect to a flow path of the fluid 36. For example, in the illustrated embodiment, the upstream housing 12 is upstream from the downstream housing 14 of the ball valve 10, because the fluid 36 flows from the upstream housing 12 toward the downstream housing 14. It should be understood that in certain embodiments the flow path of the fluid 36 may be in an opposite direction such that the structural features of the upstream housing 12 and the downstream housing 14 are exchanged (e.g., the fluid 36 flows from an adapter to a body of the housing 11).

As illustrated in FIG. 1, the ball valve 10 also includes an upstream seat assembly 38 (e.g., an upstream annular seat assembly or a first annular seat assembly) positioned between the ball 16 and the upstream housing 12, and a downstream seat assembly 40 (e.g., a downstream annular seat assembly or a second annular seat assembly) positioned between the ball 16 and the downstream housing 14. In certain embodiments, the seat assemblies 38, 40 may have the same configuration and may be used interchangeably. As discussed in more detail below, the upstream seat assembly 38 may include a seat body 42 (e.g., annular seat body) and a seal 44 (e.g., annular seal or lip seal), the downstream seat assembly 40 may include a seat body 48 (e.g., annular seat body) and a seal 50 (e.g., annular seal or lip seal). In certain embodiments, the seal 44 supports or is coupled to a biasing member 46 (e.g., annular biasing member or spring), and the seal 50 supports or is coupled to a biasing member 52 (e.g., annular biasing member or spring).

During operation of the ball valve 10, the seat assemblies 38, 40 may create respective seals between the ball 16 and the upstream housing 12 and between the ball 16 and the downstream housing 14. The seat assemblies 38, 40 may be configured to move (e.g., axially) relative to the housing 11 and/or the ball 16 and may enable the ball 16 to move (e.g., axially) relative to the housing 11 in response to pressure differentials across various components within the ball valve 10. As discussed in more detail below, such a configuration may enable the seat assemblies 38, 40 to automatically relieve pressure within a cavity 60 defined by the housing 11 and located between the seat assemblies 38, 40.

In some embodiments, when the ball 16 of the ball valve 10 moves from the open position to the closed position 24, fluid may be trapped within the cavity 60 of the ball valve 10, and a cavity pressure, P_{cavity}, may be approximately the same as an upstream pressure, Pᵤₚₛₜᵣₑₐₘ, for at least some period of time after reaching the closed position 24. In certain embodiments, a downstream pressure, P_{downstream}, within the downstream housing 14 is relieved or released after the ball valve 10 is moved from an open position to the closed position 24. Thus, in the closed positioned 24, the upstream pressure, Pᵤₚₛₜᵣₑₐₘ, exceeds the downstream pressure, P_{downstream}, and the ball 16 and the downstream seat assembly 40 may be driven to move in an axial direction 62 relative to the housing 11 and may form a seal (e.g., annular seal) between the ball 16 and the downstream housing 14 that blocks fluid flow across the ball valve 10.

As discussed in more detail below, the seat assemblies 38, 40 may include features that enable the ball valve to self-relieve (e.g., automatically relieve) the cavity pressure, P_{cavity}, while blocking fluid flow across the ball valve 10 from the upstream bore 32 of the upstream housing 12 to the downstream bore 34 of the downstream housing 14. For example, while the ball valve 10 is in the closed position 24, if the cavity pressure, P_{cavity}, exceeds a threshold pressure (e.g., the upstream pressure, Pᵤₚₛₜᵣₑₐₘ), the cavity pressure, P_{cavity}, may drive the upstream seat assembly 38 axially relative to the ball 16 and the upstream housing 12, thereby causing the upstream seat assembly 38 to separate from the ball 16 and enabling the cavity pressure, P_{cavity}, to release into the upstream bore 32 of the upstream housing 12. While the cavity pressure, P_{cavity}, is released into the upstream bore 32, the downstream seat assembly 40 may maintain the seal between the ball 16 and the downstream housing 14 to block fluid flow across the ball valve 10. To facilitate discussion, the ball valve 10 and the components therein may be described with reference to the axial axis or direction 62, a radial axis or direction 66, and/or a circumferential axis or direction 68.

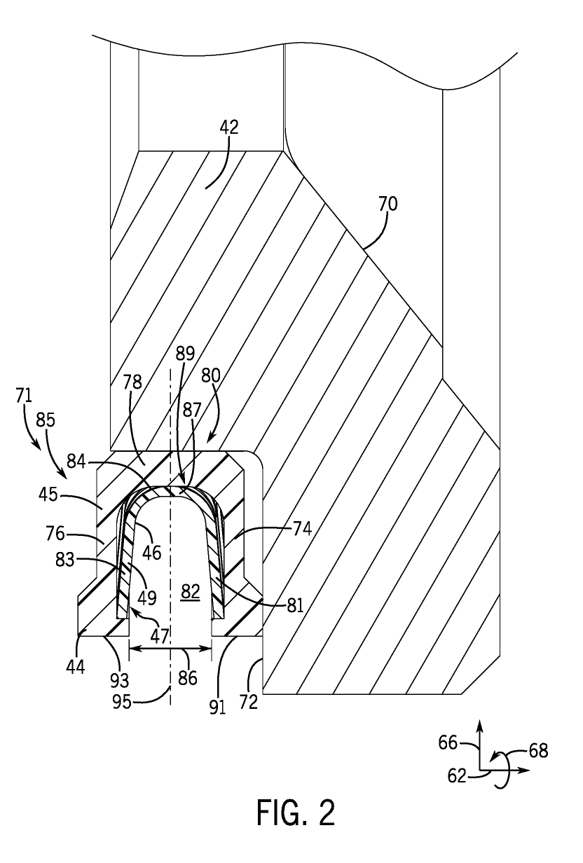

With the foregoing in mind, FIG. 2 is a cross-sectional view of the upstream seat assembly 38 in an undeformed position 71 (e.g., prior to assembly within the ball valve 10). In certain embodiments, the downstream seat assembly 40 may have the same configuration and features. As shown, the upstream seat assembly 38 includes the body 42 and the seal 44, which are physically separate components. Such a configuration may enable the use of different materials in the body 42 and the seal 44. For example, in some embodiments, the body 42 may be formed from a metal or metal alloy material (e.g., steel, aluminum, nickel, or the like) and the seal 44 may be formed from a plastic or polymeric material (e.g., Polytetrafluoroethylene [PTFE], rubber, or the like) or a composite material. In some embodiments, the body 42 may be formed from a first type of plastic or polymeric material, and the seal 44 may be formed from a second, different type of plastic or polymeric material. In certain embodiments, the body 42 may be formed from a harder, less elastic, and/or more rigid material as compared to the seal 44, which may enable the body 42 to withstand the forces applied to the body 42 during operation of the ball valve 10 and enable the seal 44 to provide a flexible seal between the body 42 and the upstream housing 12. For example, a hardness (e.g., Shore scale, Rockwell scale, Brinnell scale, etc.) of the seal 44 may be between approximately 10 to 90, 20 to 50, or 30 to 40 percent less than a hardness of the body 42. In some embodiments, an elasticity (e.g., Young's modulus) of the body 42 may be between 0.1 and 50, 0.2 and 10, or 1 to 5 percent less than an elasticity of the seal 44. Such a configuration may also facilitate manufacturing of the body 42 and/or the seal 44. For example, in some embodiments, the seal 44 may be manufactured in a first manufacturing process or step and/or at a first manufacturing facility, and the body 42 may be manufactured in a second, separate manufacturing process or step and/or at a second manufacturing facility. Furthermore, the body 42 and the seal 44 may be separately installed or assembled (e.g., in separate steps) within the ball valve 10. Such a configuration may also facilitate inspection, maintenance, and/or repair of the body 42 and/or the seal 44. For example, during maintenance or repair operations, an operator may determine that the body 42 is intact but that the seal 44 is damaged. Accordingly, the damaged seal 44 may be discarded, and a new seal 44 may be used with the same body 42.

As shown, the body 42 includes a ball-contacting surface 70 (e.g., annular surface) configured to directly contact the ball 16 of the ball valve 10 and a seal-receiving groove 72 (e.g., annular groove) configured to receive and/or to support the seal 44. The seal 44 may have a grooved annular wall 43, which has a c-shaped, u-shaped, or v-shaped cross-section 45 extending circumferentially 68 about a central axis 95. The grooved annular wall 43 may include a first radially-extending arm 74 (e.g., annular arm or portion) and a second radially-extending arm 76 (e.g., annular arm or portion), which may be joined together at respective radially-inner portions and/or by a bend 78 (e.g., annular bend or bend portion) at a radially-inner portion 80 of the seal 44. In the undeformed position 71, the radially-extending arms 74, 76 may be generally parallel to one another or angled in a first direction or at a first angle along the central axis 95 of the seal 44. In the illustrated embodiment, the first radially-extending arm 74 is configured to directly contact the body 42, and the second radially-extending arm 76 is configured to directly contact the upstream housing 12 when the upstream seat assembly 38 is assembled within the ball valve 10. Thus, in operation, the upstream seat assembly 38 may extend axially between and form a seal between the body 42 and the upstream housing 12.

As shown, the biasing member 46 is a cantilever spring having a grooved annular wall 47, which has a c-shaped, u-shaped, or v-shaped cross-section 49 extending circumferentially 68 about the central axis 95 and is positioned within a cavity 82 (e.g., annular cavity) defined between the first radially-extending arm 74 and the second radially-extending arm 76 of the seal 44. The grooved annular wall 47 of the biasing member 46 may include a first radially-extending arm 81 (e.g., annular arm or portion) and a second radially-extending arm 83 (e.g., annular arm or portion), which may be joined together at respective radially-inner portions and/or by a bend 87 (e.g., annular bend or bend portion) at a radially-inner portion 89 of the biasing member 46. In the undeformed position 71, the radially-extending arms 81, 83 may be generally parallel to one another or angled in a first direction or at a first angle along the central axis 95 of the seal 44. The biasing member 46 may be held in place within the cavity 82 via protrusions 91, 93 (e.g., inwardly extending annular protrusions) at the respective radially-outer ends of the radially-extending arms 74, 76 of the seal 44. As shown, the radially-inner portion 89 of the biasing member 46 may directly contact and may be supported by an annular surface 84 of the radially-inner portion 80 of the seal 44. The biasing member 46 may be formed from any suitable material, such as metal or metal alloy material, a plastic or polymeric material, or a composite material, for example. In some embodiments, the biasing member 46 is formed from a material that is different from a respective material of the body 42 and/or the seal 44.

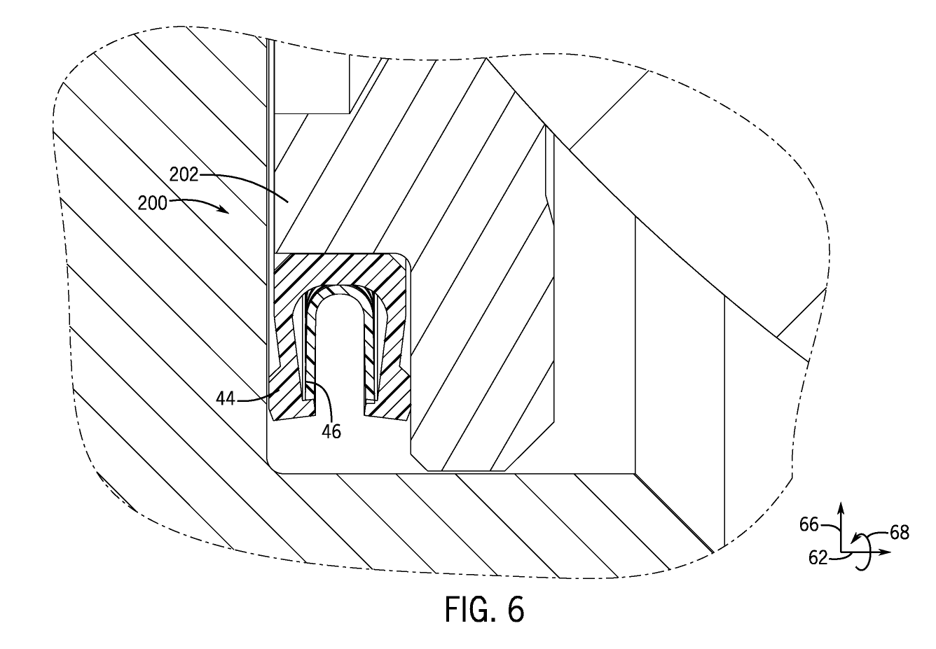

The biasing member 46 may be configured to resist axial compression and may bias the first radially-extending arm 74 and the second radially-extending arm 76 of the seal 44 away from one another along the axial axis 62. As shown, in the undeformed position 71, respective radially-outer ends of the first radially-extending arm 74 and the second radially-extending arm 76 are separated by an initial distance 86 (e.g., a first distance). In the illustrated embodiment, the seal 44 is a one-piece structure and may be formed from a single material, and together the seal 44 and the biasing member 46 form a seal assembly 85 that is configured to form an annular seal between the body 42 and the upstream housing 12 without additional components in the seal assembly 85 and/or without other components or structures positioned in the groove 72 between the body 42 and the upstream housing 12. Similarly, in certain embodiments, the body 42 may be a one-piece structure and/or may be formed from a single material. The body 42 may have any suitable configuration or geometry, including an alternative cross-sectional shape shown in FIG. 6.

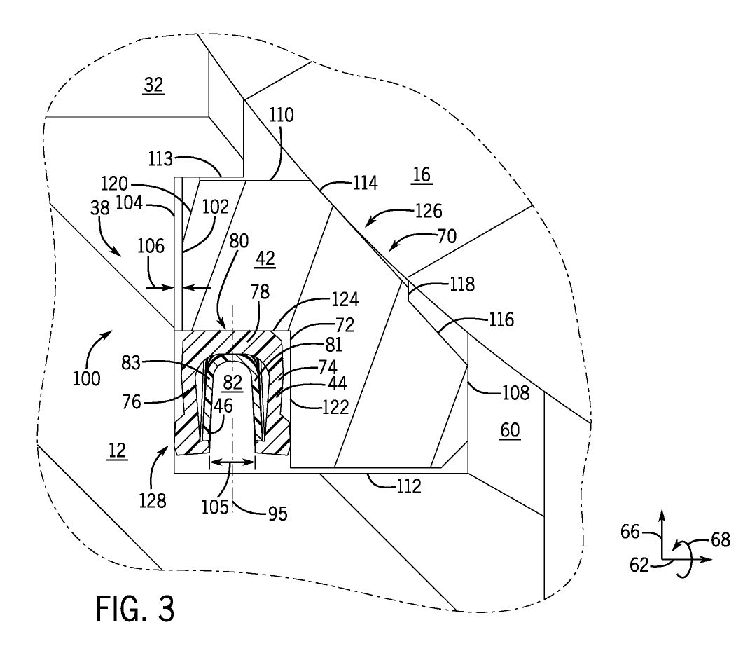

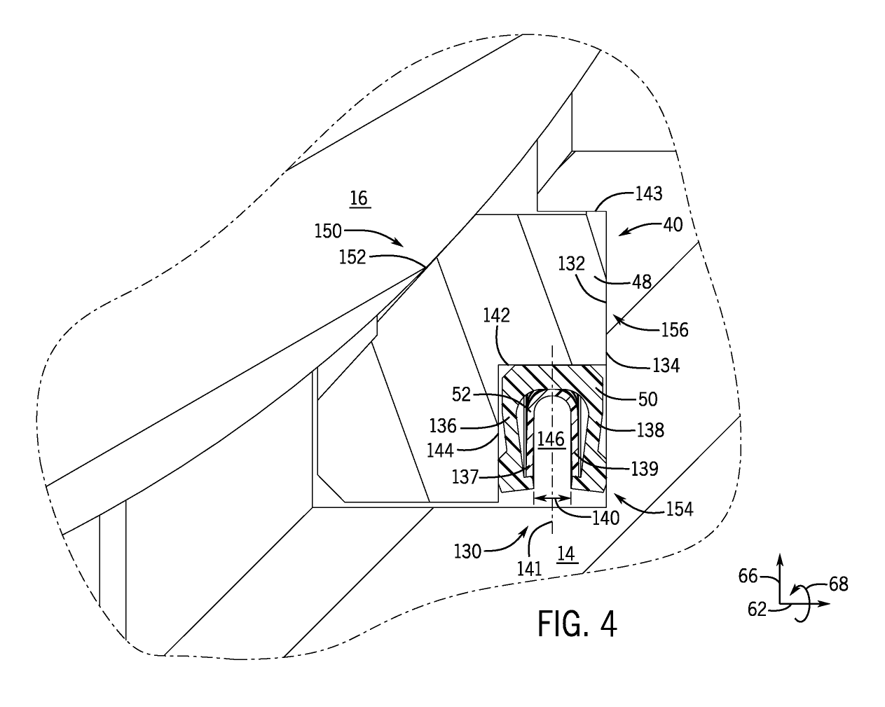

FIG. 3 is a cross-sectional view of the upstream seat assembly 38 positioned within the ball valve 10 and in a first position 100 relative to the upstream housing 12, and FIG. 4 is a cross-sectional view of the downstream seat assembly 40 positioned within the ball valve 10 and in a first position 130 relative to the downstream housing 14. The upstream seat assembly 38 may be in the first position 100 and the downstream seat assembly 40 may be in the first position 130 when the ball valve 10 is closed and the upstream pressure, Pᵤₚₛₜᵣₑₐₘ, is approximately equal to the cavity pressure, P_{cavity}, and greater than the downstream pressure, P_{downstream}. As discussed in more detail below, under such conditions, the ball 16 and the downstream seat assembly 40 may be driven in the axial direction 62, and the biasing member 46 of the upstream seat assembly 38 may relax such that the body 42 of the upstream seat assembly 40 moves in the axial direction 62 away from the upstream housing 12 and maintains contact with the ball 16, while the seal 44 maintains the seal between the body 42 and the upstream housing 12.

As shown in FIG. 3, in the first position 100, a first axially-facing surface 102 (e.g., annular surface or upstream surface) of the body 42 may be separated from an axially-facing surface 104 of the upstream housing 12 by a first distance 106 and/or the respective radially-outer ends of the radially-extending arms 74, 76 of the seal 44 may be separated by a first distance 105. The first distance 105 may be less than the initial distance 86 shown in FIG. 2 as the seal 44 is slightly deformed (e.g., elastically deformed) and the biasing member 46 is slightly compressed in the axial direction 60 (e.g., as compared to the undeformed position 71 prior to installation within the ball valve 10) when positioned between the ball 16 and the upstream housing 12. As shown, both radially-extending arms 74, 76 of the seal 44 and/or both radially-extending arms 81, 83 of the biasing member 46 may move toward one another along the axial axis 62 such that the seal 44 and/or the biasing member 46 are generally symmetrical about the central axis 95 when deformed or compressed. In certain embodiments, both radially-extending arms 74, 76 of the seal 44 and/or both radially-extending arms 81, 83 of the biasing member 46 may be angled in a second direction or at a second angle along the central axis 95 when deformed or compressed.

As shown, the body 42 includes the first axially-facing surface 102, a second axially-facing surface 108 (e.g., annular surface, axially downstream surface), a radially-inner surface 110 (e.g., annular surface), and a radially-outer surface 112 (e.g., annular surface). As shown, the ball-contacting surface 70 is a tapered or angled surface (e.g., relative to the axial axis 62) and extends generally between the radially-inner surface 110 and the second-axially facing surface 108. As shown, in certain embodiments, the ball-contacting surface 70 includes a first portion 114 proximate to the radially-inner surface 110 and that is configured to seal against the ball 16, and the first portion 114 is joined to a second portion 116 of the ball-contacting surface 70 via a radially-extending portion 118. Such a configuration may limit the contact surface area between the ball-contacting surface 70 and the ball 16, which in turn may increase a contact pressure between the body 42 and the ball 16 and form a more effective annular seal between the body 42 and the ball 16. In certain embodiments, the body 42 includes a tapered or angled surface 120 (e.g., beveled edge, annular surface) that extends from the radially-inner surface 110 and the first axially-facing surface 102. As shown, the body 42 is positioned within a recess 113 (e.g., annular recess) of the upstream housing 12.

In the illustrated embodiment, the seal 44 is positioned within the seal groove 72 of the body 42 and is configured to form a seal (e.g., annular seal) between the body 42 and the upstream housing 12. In particular, the first radially-extending arm 74 is configured to directly contact and to seal against an axially-facing surface 122 (e.g., annular surface) of the groove 72 of the body 42, and the second radially-extending arm 76 is configured to directly contact and to seal against the axially-facing surface 104 of the upstream housing 12. As shown, the radially-inner portion 80 of the seal 44 is supported by and/or directly contacts an axially-extending surface 124 (e.g., annular surface) of the groove 72 of the body 42. In the illustrated embodiment, the biasing member 46 is positioned within the cavity 82 defined between the first radially-extending arm 74 and the second radially-extending arm 76 of the seal 44, and the biasing member 46 may be configured to bias the first radially-extending arm 74 and the second radially-extending arm 76 of the seal 44 away from one another along the axial axis 62 to drive the first radially-extending arm 74 against the axially-facing surface 122 of the groove 72 of the body 42 and to drive the second radially-extending arm 76 against the axially-facing surface 104 of the upstream housing 12. As shown, together the seal 44 and the biasing member 46 form an annular seal between the body 42 and the upstream housing 12 without additional components or structures positioned in the groove 72 between the body 42 and the upstream housing 12.

As shown in FIG. 3, when the ball valve 10 is in the closed position 24 and the upstream pressure, Pᵤₚₛₜᵣₑₐₘ, is approximately equal to the cavity pressure, P_{cavity}, and greater than the downstream pressure, P_{downstream}, the upstream seat assembly 38 may provide a first seal 126 (e.g., annular seal) between the ball-contacting surface 70 of the body 42 and the ball 16 and a second seal 128 (e.g., annular seal) between the seal 44 and the upstream housing 12. Thus, fluid may not flow across the upstream seat assembly 38 between the bore 32 of the upstream housing 12 and the cavity 60.

With reference to FIG. 4, the downstream seat assembly 40 may be in the first position 130 due to the upstream pressure, Pᵤₚₛₜᵣₑₐₘ, driving the ball 16 and the downstream seat assembly 40 in the axial direction 62. As shown, in the first position 130, a first axially-facing surface 132 (e.g., annular surface or downstream surface) of the body 48 may contact an axially-facing surface 134 of the downstream housing 14 and/or the seal 50 may be deformed such that a first radially-extending arm 136 and a second radially-extending arm 138 are separated by a second distance 140. The second distance 140 may be less than an initial distance (e.g., the initial distance 86 shown in FIG. 2), because the seal 50 is deformed and the biasing member 52 is compressed in the axial direction 60 (e.g., as compared to the undeformed position 71 prior to installation within the ball valve 10) when the downstream seat assembly 40 is in the first position 130. As shown, both radially-extending arms 136, 138 of the seal 44 and/or both radially-extending arms 137, 139 of the biasing member 46 may move toward one another along the axial axis 62, such that the seal 44 and/or the biasing member 52 are generally symmetrical about a central axis 141 of the seal 50 when deformed or compressed. In certain embodiments, both radially-extending arms 136, 138 of the seal 50 and/or both radially-extending arms 137, 139 of the biasing member 52 may be angled in a second direction or at a second angle along the central axis 141 when deformed or compressed. In the illustrated embodiment, the body 48 is positioned within a recess 143 (e.g., annular recess) of the downstream housing 14. As shown, the body 48, the seal 50, and the biasing member 52 of the downstream sealing assembly 40 have the same structural configuration as the body 42, the seal 44, and the biasing member 46 of the upstream sealing assembly 38. Although different numerical reference numbers are used for clarity, it should be understood that the body 48, the seal 50, and the biasing member 52 may include some or all of features discussed above with respect to the body 42, the seal 44, and the biasing member 46.

As shown, the seal 50 is positioned within a seal groove 142 (e.g., annular groove) of the body 48 and is configured to form a seal (e.g., annular seal) between the body 48 and the downstream housing 14. In particular, the first radially-extending arm 136 is configured to contact and to seal against an axially-facing surface 144 of the seal groove 142 of the body 48, and the second radially-extending arm 138 is configured to contact and to seal against the axially-facing surface 134 of the downstream housing 14. In the illustrated embodiment, the biasing member 52 is positioned within a cavity 146 defined between the first radially-extending arm 136 and the second radially-extending arm 138 of the seal 50, and the biasing member 52 may be configured to bias the first radially-extending arm 136 and the second radially-extending arm 138 of the seal 50 away from one another along the axial axis 62 to drive the first radially-extending arm 136 against the axially-facing surface 144 of the seal groove 132 of the body 46 and to drive the second radially-extending arm 138 against the axially-facing surface 134 of the downstream housing 14, while enabling movement of the ball 16 and the body 50 along the axial axis 62.

As shown in FIG. 4, when the ball valve 10 is in the closed position 24 and the upstream pressure, Pᵤₚₛₜᵣₑₐₘ, is approximately equal to the cavity pressure, P_{cavity}, and greater than the downstream pressure, P_{downstream}, the ball 16 and the downstream seat assembly 40 are driven in the axial direction 62, thereby deforming the seal 50 and enabling the downstream seat assembly 40 to move toward the first position 130 relative to the downstream housing 14 (e.g., to enable contact between the surfaces 132, 134). In the first position 130, a first seal 150 (e.g., annular seal) may be formed between a ball-contacting surface 152 of the body 48 and the ball 16, a second seal 154 (e.g., annular seal) may be formed between the seal 50 and the axially-facing surface 134 of the downstream housing 14, and/or a third seal 156 may be formed between the axially-facing surfaces 132, 134. Thus, fluid may not flow across the downstream seat assembly 40 between the cavity 60 and the downstream bore 34 of the downstream housing 14 while the ball valve 10 is in the closed position 24.

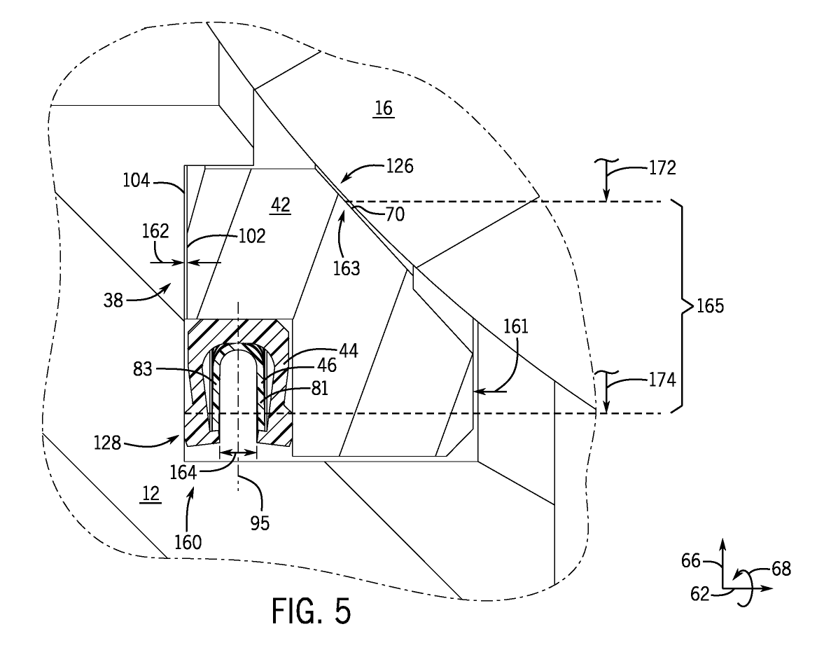

FIG. 5 is a cross-sectional view of the upstream seat assembly 38 positioned within the ball valve 10 and in a second position 160 relative to the upstream housing 12. The upstream seat assembly 38 may be in the second position 160 when the ball valve 10 is in the closed position 24 and the cavity pressure, P_{cavity}, exceeds a threshold pressure (e.g., the upstream pressure, Pᵤₚₛₜᵣₑₐₘ). In the second position 160, fluid within the cavity 60 may exert a force 161 on the body 42 that drives the body 42 away from the ball 16 and creates a gap 163 (e.g., annular gap) between the body 42 and the ball 16 (e.g., between the ball-contacting surface 70 and the ball 16, thereby breaking the seal 126) to enable fluid flow across the seal 126 to relieve the cavity pressure, P_{cavity}. In the second position 160, the first axially-facing surface 102 of the body 42 may contact the axially-facing surface 104 of the upstream housing 12 or the surfaces 102, 104 may be separated by a second axial distance 162 that is less than the first axial distance 106 shown in FIG. 3. In some embodiments, in the second position 160, the surfaces 102, 104 may contact one another. As the body 42 is driven away from the ball 16, the seal 44 may be deformed and the biasing member 46 may be compressed such that an axial distance 164 between the respective ends of the radially-extending arms 74, 76 is less than the initial distance 86 shown in FIG. 2 and/or the first distance 105 shown in FIG. 3. As shown, both radially-extending arms 74, 76 of the seal 44 and/or both radially-extending arms 81, 83 of the biasing member 46 may move toward one another along the axial axis 62, such that the seal 44 and/or the biasing member 46 are generally symmetrical about the central axis 95 when deformed or compressed. In certain embodiments, both radially-extending arms 74, 76 of the seal 44 and/or both radially-extending arms 81, 83 of the biasing member 46 may be angled in a second direction or at a second angle along the central axis 95 when deformed or compressed in the second position 160. Thus, the upstream seat assembly 38 may be configured to move relative to the upstream housing 12 to relieve the cavity pressure, P_{cavity}, and/or to substantially balance pressure across the upstream seat assembly 38. The upstream pressure, Pᵤₚₛₜᵣₑₐₘ, may continue to drive the ball 16 in the axial direction 62, and the downstream seat assembly 40 may remain in the first position 130 shown in FIG. 4 and/or may maintain the seal between the ball 16 and the downstream housing 14 while the upstream seat assembly 38 is in the second position 160 and/or while the upstream seat assembly 38 moves to relieve the cavity pressure, P_{cavity}, into the upstream bore 32.

As shown in FIG. 5, the first seal 126 between the body 42 and the ball 16 may have a first diameter 172 and the second seal 128 between the seal 44 and the upstream housing 128 may have a second diameter 174 that is greater than the first diameter 172. For clarity, the first diameter 172 and the second diameter 174 are also illustrated in FIG. 1. Such a configuration may enable the trapped fluid within the cavity 60 to exert the force 161 across a surface area 165 (e.g., annular surface area) of the upstream seat assembly 38 to drive the body 42 away from the ball 16, and may enable the trapped fluid to drive the body 42 away from the ball 16 when the cavity pressure, P_{cavity}, exceeds the upstream pressure, Pᵤₚₛₜᵣₑₐₘ.

In some embodiments, if the upstream pressure Pᵤₚₛₜᵣₑₐₘ exceeds the cavity pressure, P_{cavity}, the upstream pressure, Pᵤₚₛₜᵣₑₐₘ, may drive the seal 44 and/or the body 42 away from the axially-facing surface 104 of the upstream housing 12, thereby breaking the seal 128 and enabling fluid flow between the upstream seat assembly 38 and the upstream housing 12 to balance pressure across the upstream seat assembly 38. In operation, the upstream pressure, Pᵤₚₛₜᵣₑₐₘ, may increase or decrease due to upstream conditions, fluid supply, temperature, or the like. Similarly, the cavity pressure, P_{cavity}, may increase or decrease due to cavity conditions, such as temperature or the like. Thus, the disclosed embodiments are configured to automatically relieve the cavity pressure, P_{cavity}, and/or to maintain a balance between the upstream pressure, Pᵤₚₛₜᵣₑₐₘ, and the cavity pressure, P_{cavity}, even during periods of fluctuating upstream pressure, Pᵤₚₛₜᵣₑₐₘ, and/or cavity pressure, P_{cavity}.

As noted the body 42 may have any suitable geometry or configuration that enables facilitates automatically relieving the cavity pressure, P_{cavity}, as well enabling the ball valve 10 to block fluid flow when in the closed position 24, as disclosed herein. For example, FIG. 6 is another embodiment of a seat assembly 200 that may be utilized in the ball valve 10 of FIG. 1. As shown, the seat assembly 200 includes a seat body 202 (e.g., annular seat body), which may be used with the seal 44 and the biasing member 46.

Advantageously, in the disclosed embodiments, the seals 44, 48 and their respective bodies 42, 46 may be physically separate components. For example, each of the seals 44, 48 may be a one-piece (e.g., unitary) structure and each of the bodies 42, 46 may be a separate one-piece structure. When installed in the ball valve 10, the seals 44, 48 and the bodies 42, 46 may not be physically attached or fastened together (e.g., by fasteners or adhesives). Such a configuration may enable the seals 44, 48 and the bodies 42, 46 to be formed from different materials. For example, the bodies 42, 46 may be formed from a harder, less elastic, and/or more rigid material as compared to the seals 44, 48, which may enable the bodies 42, 46 to withstand the forces applied to the bodies 42, 46 during operation of the ball valve 10 and enable the seals 44, 48 to provide a flexible seal between the bodies 42, 46 and the housing 11. The disclosed embodiments also enable the seals 44, 48 and the biasing members 46, 52 to deform more than the respective bodies 42, 48 of the seat assemblies 38, 40 during assembly and/or during operation of the ball valve 10. Indeed, in some embodiments, the respective bodies 42, 48 may not substantially deform during assembly and/or during operation of the ball valve 10. More specifically, in certain embodiments, the only substantial deformation of the seat assemblies 38, 40 during assembly and/or operation of the ball valve 10 are to the seals 44, 48 and the biasing members 46, 52. The disclosed embodiments may also facilitate manufacturing of the bodies 42, 46 and/or the seals 44, 48. Additionally, the disclosed embodiments may also facilitate installation, inspection, maintenance, and/or repair of the seat assemblies 38, 40 and their components.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A ball valve, comprising:
a housing;
a ball disposed within a cavity of the housing and configured to rotate between an open position and a closed position;
an annular seat assembly positioned between the housing and the ball, wherein the annular seat assembly comprises:
an annular seat body comprising a ball-contacting surface configured to contact the ball and an annular groove; and
an annular seal positioned within the annular groove, wherein the annular seal is configured to contact and to form a seal between the annular seat body and the housing and enables the annular seat body to move relative to the housing to automatically relieve a cavity pressure within the cavity across the annular seat assembly into an upstream bore of the housing.

2. The ball valve of claim 1, wherein the annular seal comprises a first radially-extending portion and a second radially-extending portion joined to one another via a bend.

3. The ball valve of claim 2, wherein the annular seal supports an annular biasing member within a cavity defined between the first and second radially-extending portions.

4. The ball valve of claim 3, wherein the annular biasing member biases the first and second radially-extending portions away from one another along an axial axis of the ball valve.

5. The ball valve of claim 1, wherein the annular seal is configured to elastically deform to enable the annular seat body to move relative to the housing.

6. The ball valve of claim 1, wherein the annular seat body comprises a first material, and the annular seal comprises a second material different than the first material.

7. The ball valve of claim 6, wherein the annular seat body comprises a first hardness, and the annular seal comprises a second hardness less than the first hardness.

8. The ball valve of claim 6, wherein the first material comprises a metal, and the second material comprises a plastic or a polymer.

9. The ball valve of claim 1, wherein a radially-inner end of the biasing member directly contacts the annular seal.

10. The ball valve of claim 1, wherein the cavity pressure is relieved through an annular gap between the annular seat body and the ball.

11. A ball valve, comprising:
an upstream housing defining an upstream bore;
a downstream housing coupled to the upstream housing and defining a downstream bore;
a ball positioned within a cavity defined between the upstream housing and the downstream housing and configured to rotate between an open position and a closed position;
an upstream annular seat assembly positioned between the upstream housing and the ball, comprising:
an upstream annular seat body configured to seal against the ball when the ball valve is in a closed position and a cavity pressure within the cavity is substantially equal to an upstream pressure in the upstream bore; and
an upstream annular seal configured to directly contact the upstream annular seat body and the upstream housing to form a seal between the upstream annular seat body and the upstream housing and to deform to enable the upstream annular seat body to move away from the ball to relieve the cavity pressure into the upstream bore when the cavity pressure exceeds the upstream pressure.

12. The ball valve of claim 11, wherein the upstream annular seal supports an annular biasing member that resists axial compression.

13. The ball valve of claim 11, wherein the cavity pressure is relieved through an annular gap between the upstream annular seat body and the ball.

14. The ball valve of claim 11, comprising a downstream annular seat assembly positioned between the downstream housing and the ball, comprising:
a downstream annular seat body configured to contact the ball; and
a downstream annular seal configured to contact the downstream annular seat body and the downstream housing to form a seal between the downstream annular seat body and the downstream housing and to deform to enable the downstream annular seat body to move relative to the downstream housing.

15. The ball valve of claim 11, wherein the upstream annular seat body comprises a first material, and the upstream annular seal comprises a second material different than the first material.

16. A system for use within a floating ball valve, comprising:
an annular seat assembly configured to be positioned between a housing and a ball of the floating ball valve, comprising:
an annular seat body configured to contact the ball;
an annular seal that is physically separate from the annular seat body, wherein the annular seal comprises a first radially-extending portion and a second radially-extending portion joined to one another via a bend; and
an annular biasing member supported within a cavity defined between the first and second radially-extending portions of the annular seal;
wherein the annular seat assembly is configured to block fluid flow across the annular seat assembly when the floating ball valve is in a closed position and a cavity pressure within a cavity on a first side of the annular seat assembly is substantially equal to a bore pressure within a bore on a second side of the annular seat assembly and to automatically separate from the ball when the cavity pressure exceeds the bore pressure to enable fluid flow between the annular seat body and the ball to relieve the cavity pressure.

17. The system of claim 16, wherein the annular biasing member biases the first and second radially-extending portions away from one another along an axial axis of the floating ball valve.

18. The system of claim 16, wherein the annular seal is configured to elastically deform and the annular biasing member is configured to compress to enable the annular seat assembly to automatically separate from the ball.

19. The system of claim 18, wherein the first and second radially-extending portions move toward one another along the axial axis of the ball valve as the annular seal deforms such that the annular seal is symmetrical about a central axis of the annular seal when deformed.

20. The system of claim 16, wherein the annular seat body comprises a first material, and the annular seal comprises a second material different than the first material.
